(19) United States
(12) Patent Application Publication
(10) Pub. No.: US 2025/0037084 A1
(43) Pub. Date: Jan. 30, 2025

(54) SERVER AND METHOD FOR GENERATING INTERVIEW QUESTIONS BASED ON ARTIFICIAL INTELLIGENCE

(71) Applicant: ableJ Inc., GYEONGGI-DO (KR)

(72) Inventors: IN HEA KANG, SEOUL (KR); JAE HO KIM, GYEONGGI-DO, (KR); KYUNG HO PARK, GYEONGGI-DO (KR)

(21) Appl. No.: 18/766,021

(22) Filed: Jul. 8, 2024

(30) Foreign Application Priority Data
Jul. 24, 2023 (KR) 10-2023-0096169

(51) Int. Cl. G06Q 10/1053

(52) U.S. Cl. CPC G06Q 10/1053

(57) ABSTRACT

In accordance with an aspect of the present disclosure, there is a server for generating a question on the basis of artificial intelligence (AI). The server includes a memory configured to store at least one instruction; and a processor. When the at least one instruction is executed by the processor, the server acquires answer sentences given by an interviewee for an interviewer's interview questions about a job that the interviewee applies for, evaluates each of a plurality of evaluation items required for evaluating suitability for the job on the basis of the acquired answer sentences; selects an additional item to be additionally evaluated from among the plurality of evaluation items on the basis of the evaluation, and generates a tail question on the basis of at least one of the selected additional item, the interview questions, and the acquired answer sentences and provides the tail question to the interviewee.

### CROSS-REFERENCE TO RELATED APPLICATION

This application claims priority to and the benefit of Korean Patent Application No. 10-2023-0096169, filed on Jul. 24, 2023, the disclosure of which is incorporated herein by reference in its entirety.

### BACKGROUND

### 1. Field of the Invention

The present invention relates to a system and method for generating interview questions on the basis of artificial intelligence (AI), and more particularly, to a server and method for generating tail questions required for evaluating an interviewee in depth.

### 2. Discussion of Related Art

Unless described otherwise in the present specification, description in this section is not conventional art of the claims of this application, and anything included in this section is not considered as conventional art.

A tail question is a follow-up question for obtaining more clarification or a more detailed answer to something said by another person. A tail question is a question used to dig deeper into the other person's previous statement or to approach the statement from a different perspective. Unlike a short-answer question that may be simply answered with “yes” or “no,” a tail question allows the other person to elaborate or develop his or her thought. In this way, it is possible to gain more depth and variety in the argument and spur more interaction with the other person.

Interviews are an important step in evaluating an interviewee's competencies, and tail questions (or in-depth questions) are asked in interviews to identify an interviewee's capabilities and qualities more accurately. Tail questions are used to elicit additional information and understanding about previously received answers and are generally used to evaluate an interviewee's analytical, problem-solving, communication, and other skills.

Tail questions are used to evaluate a corresponding competency more accurately by diving deeper than simply accepting an answer given by an interviewee. Interviewees have the opportunity to elaborate and demonstrate their knowledge, experience, competencies, and ability to handle challenges through their answers to tail questions.

### SUMMARY OF THE INVENTION

The present invention is directed to providing a server and method for generating questions in interviews, in which tail questions are generated to identify an interviewee's competencies in depth. According to exemplary embodiments, an interviewee's previous answers are analyzed to generate a tail question about an evaluation item that is unidentifiable from the previous answers. In this way, artificial intelligence (AI) is used to replace a portion or entirety of the role of an interviewer.

In accordance with an aspect of the present disclosure, there is a server for generating a question on the basis of artificial intelligence (AI). The server includes a memory configured to store at least one instruction; and a processor; wherein, when the at least one instruction is executed by the processor, the server acquires answer sentences given by an interviewee for an interviewer's interview questions about a job that the interviewee applies for, evaluates each of a plurality of evaluation items required for evaluating suitability for the job on the basis of the acquired answer sentences; selects an additional item to be additionally evaluated from among the plurality of evaluation items on the basis of the evaluation, and generates a tail question on the basis of at least one of the selected additional item, the interview questions, and the acquired answer sentences and provides the tail question to the interviewee.

Further, the server may understand content of data submitted by the interviewee, which includes a cover letter, a resume, credentials, and a portfolio, and generates an additional question about the content of the submitted data.

Further, the server may select and combine some of all questions and answers provided to and by the interviewee as well as an immediately previous question and answer to generate the tail question.

Further, the plurality of items may include key competencies required for the job.

Further, the plurality of items may include situation, task, action, and result which are defined in a situation, task, action, and result (STAR) technique.

Further, the server may evaluate the interviewee's level or emotion and adjusts difficulty of the tail question according to the interviewee's evaluated level.

Further, after providing the tail question to the interviewee, the server additionally may provide an example answer for the tail question to the interviewee.

Further, the example answer is provided when the interviewee is estimated to be nervous or a level of answers is determined to be a certain level or lower.

Further, the server may extract an item that is unidentified from the content of the data submitted by the interviewee and generates an additional question for evaluating the item.

Further, when the interviewee's nervousness exceeds a certain level or the interviewee is silent for a certain period of time or more or stops speaking while answering, the server may generate an icebreaking question for changing an atmosphere or outputs a nervousness relaxation message.

### DETAILED DESCRIPTION OF EXEMPLARY EMBODIMENTS

Hereinafter, exemplary embodiments of the present invention will be described in detail with reference to the accompanying drawings. Throughout the drawings, like reference numerals will be given to like components, and description thereof will not be reiterated. The suffixes “module” and “unit” for components used in the description below are assigned or interchangeably used for ease of specification only, and do not have distinct meanings or roles therein. In describing an exemplary embodiment disclosed herein, when the detailed description of a related known technology is determined to obscure the subject matter of the exemplary embodiment, the detailed description will be omitted. The accompanying drawings are provided only to help understanding of exemplary embodiments disclosed herein. The technical spirit disclosed herein is not limited to the accompanying drawings and should be construed as including all modifications, equivalents, and substitutions within the spirit and technical scope of the present invention.

Terms including ordinal numbers, such as “first,” “second,” and the like, may be used to describe various components, but the components are not limited by the terms. The terms are only used to distinguish one component from others.

When a component is referred to as being “connected” or “coupled” to another component, the two components may be “directly connected” or may be “indirectly connected” with an intermediate component therebetween. On the other hand, when a component is referred to as being “directly connected” or “directly coupled” to another component, there is no intermediate component.

In this application, the terms “include,” “have,” and the like are intended to represent the presence of features, numerals, steps, operations, components, parts, or combinations thereof and do not preclude the presence or addition of one or more other features, numerals, steps, operations, components, parts, or combinations thereof.

In the present specification, “units” include units implemented by hardware, units implemented by software, and units implemented by both. Also, one unit may be implemented by two or more pieces of hardware, and two or more units may be implemented by one piece of hardware.

In the present specification, some operations or functions described as being performed by a terminal, an apparatus, or a device may be performed instead by a server connected to the terminal, the apparatus, or the device. Similarly, some operations or functions described as being performed by a server may be performed instead by a terminal, an apparatus, or a device connected to the server.

Hereinafter, the present invention will be described in detail with reference to the accompanying drawings.

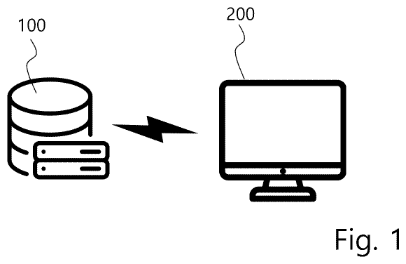

FIG. 1 is a diagram illustrating a configuration of a system for generating interview questions on the basis of artificial intelligence (AI) according to an exemplary embodiment.

Referring to FIG. 1, the system for generating interview questions on the basis of AI according to the exemplary embodiment may include a question generation server 100 and an interviewing terminal 200.

The question generation server 100 collects an interviewer's question information or an interviewee's answer information from the interviewing terminal 200 and analyzes the collected question or answer information to generate a tail question for identifying the interviewee's competencies. Subsequently, the question generation server 100 transmits the generated tail question to the interviewing terminal 200 to provide the tail question to the interviewee. According to the exemplary embodiment, the question generation server 100 implements AI as the interviewer using a deep learning model including a language model and generates a tail question for identifying the interviewee's competencies in depth.

Through server-client communication with the question generation server 100, the interviewing terminal 200 transmits the question information or answer information generated during the interview process to the question generation server 100 and receives the tail questions to be provided to the interviewee from the question generation server 100 to output the tail questions. According to the exemplary embodiment, the question and answer information may be generated in the form of a record file, video, or the like in which the questions and answers are recorded. According to the exemplary embodiment, the question and answer information may be generated by a camera, a recorder, or the like installed in the interviewing terminal 200.

According to the exemplary embodiment, at least one interviewing terminal 200 may be implemented as a computer that may access a remote server or terminal through a network. For example, the computer may be a navigation device, a notebook computer, a desktop computer, a laptop computer, or the like on which a web browser is installed. Here, the at least one interviewing terminal 200 may be implemented as a terminal that may access a remote server or terminal through a network. The at least one interviewing terminal 200 is, for example, a wireless communication device with portability and mobility and may be any type of handheld wireless communication device such as a Personal Communication System (PCS) device, a Global System for Mobile Communications (GSM) device, a Personal Digital Cellular (PDC) device, a Personal Handyphone System (PHS) device, a personal digital assistant (PDA) device, an International Mobile Telecommunication (IMT)-2000, a Code Division Multiple Access (CDMA)-2000 device, a Wideband CDMA (WCDMA) device, a Wireless Broadband Internet (WiBro) terminal, a smartphone, a smart pad, a tablet personal computer (PC), and the like.

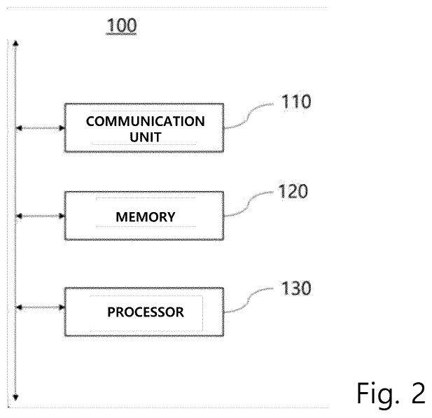

FIG. 2 is a diagram showing a data processing configuration of a question generation server according to an exemplary embodiment.

Referring to FIG. 2, the question generation server 100 according to the exemplary embodiment may include a communication unit 110, a memory 120, and a processor 130.

The configuration of the question generation server 100 shown in FIG. 2 is merely a simple example. According to the exemplary embodiment, the question generation server 100 may include other components to provide a computing environment for generating a tail question, or only some of the disclosed components may be included in the question generation server 100.

The communication unit 110 may support any type of communication, such as wired communication, wireless communication, and the like, and may be configured for various communication networks such as a personal area network (PAN), a wide area network (WAN), and the like. Also, the communication unit 110 may operate on the basis of the well-known World Wide Web (WWW) and employ a wireless transmission technology used for short-range communication such as Infrared Data Association (IrDA) or Bluetooth. As an example, the communication unit 110 may handle transmission and reception of data required for performing a technique according to an exemplary embodiment of the present disclosure.

The memory 120 may be any type of storage medium. For example, the memory 120 may be at least one type of storage medium among a flash memory, a hard disk, a multimedia card, a card-type memory (e.g., a secure digital (SD) memory, an extreme digital (XD) memory, or the like), a random access memory (RAM), a static RAM (SRAM), a read-only memory (ROM), an electrically erasable programmable ROM (EEPROM), a programmable ROM (PROM), a magnetic memory, a magnetic disk, and an optical disc. The memory 120 may constitute a database.

The memory 120 may store at least one instruction that is executable by the processor 130. Also, the memory 120 may store any form of information generated or determined by the processor 130 and any form of information received by the question generation server 100. For example, the memory 120 may store a verb evaluation table, which will be described below, and a plurality of tail questions.

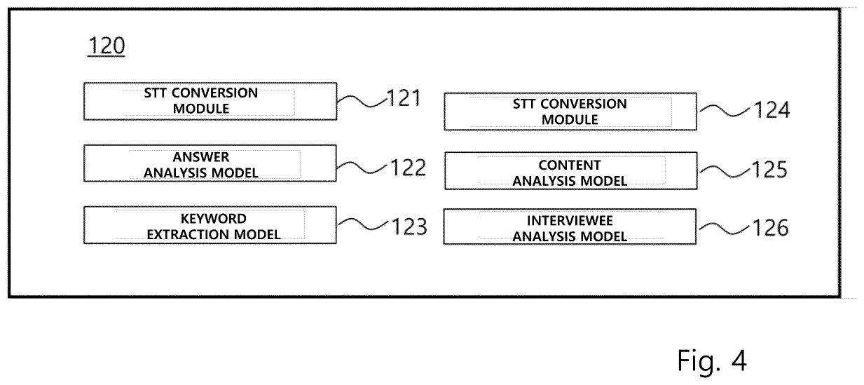

The memory 120 may store various types of modules and models. Referring to FIG. 4 which shows a module and models stored in the memory 120, the memory 120 may store at least one of a speech-to-text (STT) conversion module 121, an answer analysis model 122, a keyword extraction model 123, a tail question generation model 124, a content analysis model 125, and an interviewee analysis model 126. Each of the module and models may have the form of an application that is executable by the processor 130.

Turning to each of the module and models, first, the STT conversion module 121 is a module designed to convert speech to text. Since the STT conversion module 121 corresponds to well-known technology, detailed description thereof will be omitted. According to the exemplary embodiment, the STT conversion module 121 recognizes speech from question and answer information generated during an interview process and converts the speech into text to generate question sentences and answer sentences.

Here, the answer analysis model 122 will be described. The answer analysis model 122 is a model designed to, when an answer is given to an interview question, evaluate an interviewee's competencies by analyzing the given answer and derive items that require additional evaluation, for example, an item of which desired information is not sufficiently included in the answer, an item that requires additional information, and the like. According to the exemplary embodiment, the answer analysis model 122 may be a model trained using a machine learning or deep learning method, and in this case, the model may be trained using a transfer learning method. Transfer learning will be simply described below.

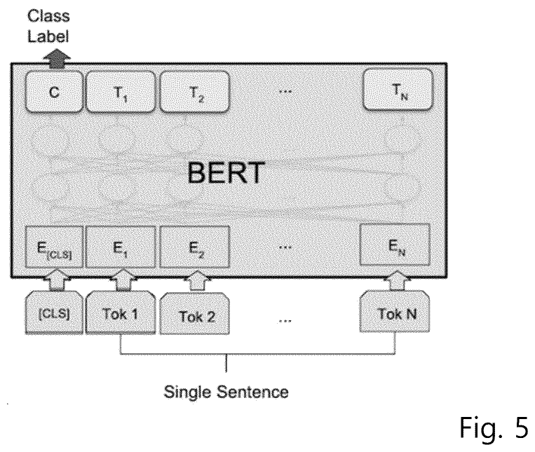

Transfer learning is a process of transferring and additionally fine-tuning a pretrained model for a specific task. Representatively, bidirectional encoder representations from transformers (BERT) is an example of the pretrained model and is shown in FIG. 5. The foregoing model is not limited to BERT and may be implemented as, for example, a generative pretrained transformer (GPT) model. Since the structure and characteristics of BERT are well known, detailed description thereof will be omitted.

According to the exemplary embodiment, the answer analysis model 122 employs a language model as a pretrained model. The language model is a model that is trained using semi-supervised learning using a large corpus and at least one of various known techniques such as masked language model (MLM) and next sentence prediction (NSP) techniques. Since MLM, NSP, and the like are well-known technologies, detailed description thereof will be omitted.

The foregoing pretrained model is combined with a layer for evaluating answer sentences, and the combined model is trained. Such training is referred to as fine-tuning because a pretrained model is fine-tuned to perform a certain task.

In fine-tuning, a plurality of pieces of training data are used. In the training data, input data for training includes interview questions and answer sentences to the interview questions, and labeling data for training includes evaluation results of the answer sentences.

Meanwhile, according to the exemplary embodiment, the input data for training may include not only interview questions or answers but also at least one of the industry of a company for which an interviewee applies, the field of application, and the interviewee's experience, sex, and age. Accordingly, for the same interview question, answers that are highly evaluated in the industries of companies may vary, and this is the same for a field for which the interviewee applies, the interviewee's experience, sex, and age, and the like.

In addition, the labeling data for training may be labeled in various ways. For example, evaluation criteria for verbs may be generated and then used for labeling evaluations of sentences. The labeling entity may be an interviewer who actually conducts the interview.

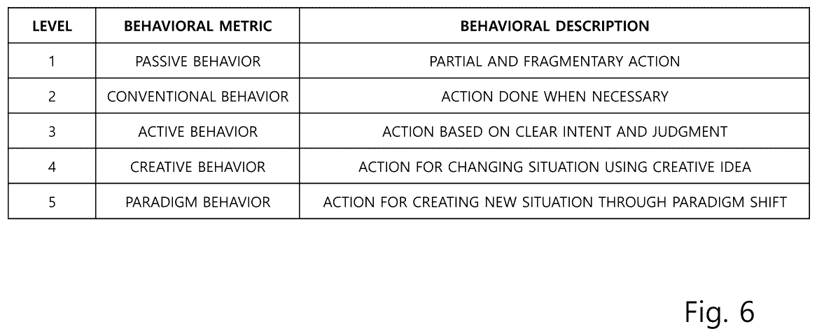

More specifically, first, verbs may be classified into various types by meaning. Referring to FIG. 6, a verb evaluation table is illustrated. According to such a verb evaluation table, there may be verbs that represent passive behaviors, verbs that represent conventional behaviors, verbs that represent active behaviors, verbs that represent creative behaviors, and verbs that represent paradigms, depending on the meanings of the verbs.

Among the types of verbs, verbs that represent passive behaviors are verbs that have meanings indicating partial or fragmentary actions. For example, the verb “prepare,” which means to prepare “as instructed” depending on context, indicates a passive action. Unlike this, the verb “accomplish” or “augment” in the context “I provided specific information to achieve a certain goal and it improved the result” indicates paradigm-shifting action.

The five levels or behavioral metrics of verbs classified as described above are illustrative, and the spirit of the present invention is not limited thereto.

Referring back to FIG. 4, the keyword extraction model 123 is a model designed to extract a keyword from a question sentence or an answer sentence. Since a technique for extracting a keyword from a sentence is well-known technology, detailed description thereof will be omitted.

The tail question generation model 124 is a model for generating a tail question to identify an evaluation item that is not disclosed in answers, according to results of analyzing an interviewer's questions and an interviewee's answers. According to the exemplary embodiments, keywords extracted from the questions and answers and evaluation item information that is not identified from the interviewee's answers are input to the tail question generation model 124. The keywords may be extracted from question sentences and answer sentences by the keyword extraction model 123. The tail question generation model 124 uses the input keywords to generate a tail question for evaluating an item that is unidentifiable from the interviewee's previous answers.

According to the exemplary embodiment, an answer evaluation level, in addition to the keywords, interview questions, answer sentences, company industry, industry or field of application for which the interviewee applies, and the interviewee's personal information, such as age, sex, or experience, may be input to the tail question generation model 124. Also, data submitted by the interviewee, such as a resume, a portfolio, and the like, may be additionally input. Then, the tail question generation model 124 may generate a tail question in consideration of the additionally input information. To this end, in the memory 120, tail questions may be organized by evaluation item, or tail questions may be organized by company industry, field of application, and the interviewee's personal information. The tail question generation model 124 searches the organized memory 120 on the basis of the foregoing input information such that a tail question matching the input information may be selected. Also, the tail question generation model 124 may generate a tail question to be provided to the interviewee through an estimation model including a language model.

The content analysis model 125 is a model for analyzing data submitted by interviewees and an algorithm for automatically analyzing and understanding given content such as text, images, audio, videos, and the like. The content analysis model 125 processes data according to a specific form of content using AI and machine learning technologies and extracts meanings or recognizes features. According to the exemplary embodiment, the content analysis model 125 may include, but is not limited to, a text analysis model, an image analysis model, an audio analysis model, a video analysis model, and the like.

The interviewee analysis model 126 is an artificial neural network model for evaluating an interviewee according to the interviewee's answers. According to the exemplary embodiment, the interviewee analysis model 126 may derive variables, such as knowledge, an experience level, competencies, qualities, confidence, and the like, on the basis of the interviewee's answers and identify the interviewee's level on the basis of each variable. Also, the interviewee analysis model 126 analyzes word choice, tone of voice, body language, and the like from question and answer information to determine the interviewee's nervousness and emotional state.

Meanwhile, each of the answer analysis model 122, the keyword extraction model 123, the tail question generation model 124, the content analysis model 125, and the interviewee analysis model 126 described above may be an estimation model trained by an artificial neural network, and such an estimation model will be briefly described below.

In the present specification, an estimation model may be any computer program that is run on the basis of a network function, an artificial neural network, and/or a neural network. Throughout the present specification, “mode,” “artificial neural network,” “network function,” and “neural network” may be interchangeably used. In a neural network, one or more nodes are connected as an input node and an output node through one or more links. Characteristics of a neural network may be determined according to the number of nodes and links in the neural network, connections between the nodes and links, and weights assigned to the links. A neural network may be a set of one or more nodes. A subset of nodes included in a neural network may constitute a layer.

A deep neural network (DNN) may be a neural network including a plurality of hidden layers in addition to an input layer and an output layer. The DNN may be a convolutional neural network (CNN), a recurrent neural network (RNN), an auto encoder, a generative adversarial network (GAN), a restricted Boltzmann machine (RBM), a deep belief network (DBN), a Q network, a U network, a Siamese network, a transformer, or the like. These are merely examples of a DNN, and the present disclosure is not limited thereto.

A neural network may be trained using at least one method among supervised learning, unsupervised learning, semi-supervised learning, self-supervised learning, and reinforcement learning. Training of a neural network may be a process of applying knowledge for a neural network to perform a specific operation to the neural network.

A neural network may be trained to minimize an error of an output. Training of a neural network is a process of inputting training data to the neural network, computing an error between an output of the neural network and a target for the training data, backpropagating the error of the neural network from an output layer toward an input layer to reduce the error, and updating a weight of each node of the neural network. In supervised learning, labeled data which is training data labeled with a correct answer may be used, and in unsupervised learning, unlabeled data which is training data labeled with no correct answer may be used. A variation of an updated connection weight of each node may be determined according to a learning rate. The computation of the neural network on the input data and the backpropagation of the error may constitute a learning cycle (epoch). The learning rate may vary depending on the number of iterations in the neural network's learning cycle. Also, to prevent overfitting, augmentation and regularization of training data, dropout in which some nodes are deactivated, a batch normalization layer, and the like may be used.

According to the exemplary embodiment, an estimation model may employ at least a part of a transformer. The transformer may be configured as an encoder for encoding embedded data and a decoder for decoding encoded data. The transformer may have a structure for receiving a set of data and outputting a set of another type of data through encoding and decoding operations. According to the exemplary embodiment, a set of data may be processed in a form that is computable by the transformer. A process of processing a set of data in the form that is computable by the transformer may include an embedding process. Expressions such as a data token, an embedding vector, an embedding token, and the like may refer to embedded data in the form that is computable by the transformer.

For the transformer to encode and decode a set of data, the encoder and decoder in the transformer may be processed using an attention algorithm. The attention algorithm may be an algorithm for calculating similarities between a given query and one or more keys, reflecting the calculated similarities in values corresponding to the keys, and then calculating a weighted sum of the values reflecting the similarities to calculate an attention value.

Attention algorithms may be classified into various types according to how a query, a key, and a value are set. For example, when a query, a key, and a value are all set to be the same to obtain an attention, this may correspond to a self-attention algorithm. When dimensions of an embedding vector are reduced to process a set of input data in parallel and an individual attention head is calculated for each partitioned embedding vector to calculate an attention, this may correspond to a multi-head attention algorithm.

According to the exemplary embodiment, the transformer may include modules that execute a plurality of multi-head self-attention algorithms or multi-head encoder-decoder algorithms. According to the exemplary embodiment, the transformer may also include additional components other than an attention algorithm, such as embedding, regularization, softmax, and the like. A method of configuring a transformer using an attention algorithm may include a method disclosed by Vaswani et al. in “Attention Is All You Need,” 2017 NIPS, which is incorporated herein by reference.

The transformer may apply embedded natural language, partitioned image data, an audio waveform, and the like to various data domains to convert a set of input data into a set of output data. To convert data of various data domains into a set of data that may be input to the transformer, the transformer may embed the data. The transformer may process additional data that expresses relative positional or phase relationships within a set of data. Alternatively, vectors expressing relative positional or phase relationships within a set of input data may be reflected in the input data such that the set of input data may be embedded. According to the exemplary embodiment, positional relationships within a set of input data may include, but are not limited to, word order in natural language sentences, relative positions of individual segmented images, a temporal order of segmented audio waveforms, and the like. A process of adding information that expresses relative positional or phase relationships within a set of input data may be referred to as positional encoding.

According to the exemplary embodiment, an estimation model may include an RNN, a long short-term memory (LSTM) network, a BERT, or a GPT.

According to the exemplary embodiment, an estimation model may be a model that is trained using a transfer learning method. Here, transfer learning is a training method of performing pretraining using a large amount of unlabeled training data on the basis of semi-supervised learning or self-supervised learning to obtain a pretrained model with a first task and training the pretrained model using labeled training data, which is fine-tuned for a second task, on the basis of supervised learning.

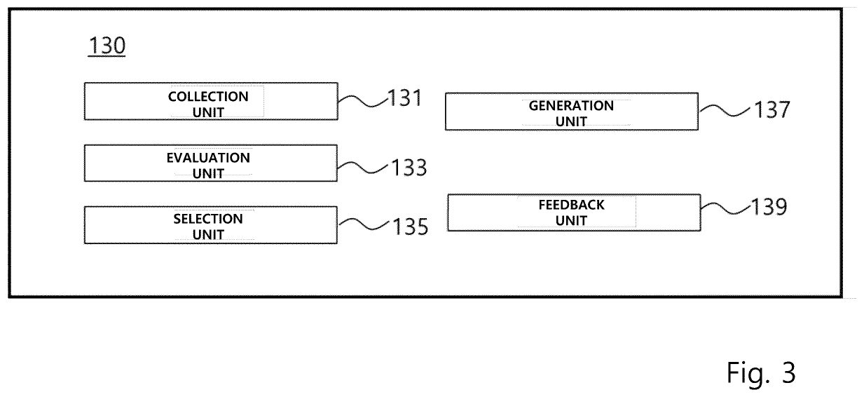

Referring back to FIG. 3, the processor 130 will be described. First, the processor 130 according to the exemplary embodiment may execute the at least one instruction stored in the memory 120 to implement technical features according to exemplary embodiments of the present disclosure to be described below. According to the exemplary embodiment, the processor 130 may include at least one core and may be a processor for data analysis and/or processing such as a central processing unit (CPU), a general-purpose graphics processing unit (GPGPU), a tensor processing unit (TPU), and the like of the question generation server 100.

FIG. 3 is a diagram showing a data processing configuration of a processor according to an exemplary embodiment.

Referring to FIG. 3, the processor 130 according to the exemplary embodiment may include a collection unit 131, an evaluation unit 133, a selection unit 135, a generation unit 137, and a feedback unit 139. As used herein, the term “unit” is construed as including software, hardware, or a combination thereof depending on the context in which the term is used. For example, the software may be machine code, firmware, embedded code, or application software. As another example, the hardware may be a circuit, a processor, a computer, an integrated circuit, an integrated circuit core, a sensor, a micro-electro-mechanical system (MEMS), a passive device, or a combination thereof.

The collection unit 131 collects an interviewer's questions and an interviewee's answers. For example, the collection unit 131 may collect a question recording file and an answer recording file from an interviewing terminal. Subsequently, the collection unit 131 acquires the interviewee's answer sentences to the interviewer's interview questions about a job that the interviewee applies for from the collected files using an STT model. For example, the collection unit 131 converts speech signals of the recording files into text and acquires question sentences and answer sentences.

The evaluation unit 133 evaluates each of a plurality of evaluation items required for evaluating suitability for the job on the basis of the acquired answer sentences. According to the exemplary embodiment, the plurality of evaluation items include core competencies required for the job. For example, the core competencies may include, but are not limited to, a problem recognition capability, a problem-solving capability, and a collaboration capability. Also, according to the exemplary embodiment, the plurality of evaluation items may include situation, task, action and result that are defined in a situation, task, action and result (STAR) technique. The STAR technique is a structured response method used to effectively express and describe experience related to a job interview or job. STAR is an abbreviation for “situation, task, action and result,” which represents a sequence to be followed by interviewees when describing their experience. Situation describes the context in which an interviewee has been present, and is information that helps others understand the interviewee's challenge, problems, background of a project, or the like. Task is information on a problem or goal to be solved or achieved by the interviewee. For example, task is information about what goal needed to be achieved or what task needed to be performed. Action is information on a measure or action taken by the interviewee in the situation. For example, action is information about what role the interviewee played, what actions the interviewee took, and how the actions contributed to solving a problem or achieving a goal. Result is information on results of actions taken by the interviewee. For example, result is information about what was achieved and what impact the actions had, and includes quantitative results or effective achievement information.

The selection unit 135 selects an additional item to be additionally evaluated from among the plurality of evaluation items on the basis of the evaluation performed by the evaluation unit 133. Also, the selection unit 135 may select at least one of a situation, a task, an action, and a result that has not been mentioned in the interviewee's answers as an additional item on the basis of the STAR technique.

Subsequently, the generation unit 137 generates a tail question on the basis of at least one of the selected additional item, the interview questions, and the acquired answer sentences. To this end, the selection unit 135 inputs the questions and answers acquired by the collection unit 131 to the answer analysis model to distinguish between items that are identifiable from the answers and items that are unidentifiable or require further identification, and selects the items that are unidentifiable or require further identification as additional items. Subsequently, the generation unit 137 inputs the interview questions, the acquired answer sentences, and the additional items to the tail question generation model to generate a tail question.

Specifically, when the interviewer's question is “Tell me about your experience working at Samsung Electronics” and the interviewee's answer is “I worked on semiconductor research as a researcher at Samsung Electronics,” items that are unidentifiable from the question and answer are the problem recognition capability and the collaboration capability. Here, the selection unit 135 selects the problem recognition capability and the collaboration capability, which are items that are unidentifiable from the answer by the answer analysis model, as additional items.

The generation unit 137 generates a tail question through the tail question generation model on the basis of at least one of the selected additional item, the interview questions, and the acquired answer questions. Continuing with the foregoing example, the generation unit 137 generates a tail question to determine the interviewee's problem recognition capability which is selected as an additional item. In other words, the generation unit 137 generates a tail question to identify an evaluation item which is unidentifiable from the interviewee's previous answer information. Specifically, the generation unit 137 generates a question, such as “If you solved any problem during your semiconductor research at Samsung Electronics, describe how you recognized the problem and what motivated you to solve it,” to identify the problem recognition capability which is one of the additional evaluation items.

According to the exemplary embodiment, the generation unit 137 may understand the content of data submitted by the interviewee and generate an additional question about the content of the submitted data. The data submitted by the interviewee includes, but is not limited to, a cover letter, a resume, credentials, a portfolio, and the like.

For example, the generation unit 137 examines the data submitted by the interviewee through the content analysis model. The content analysis model is an algorithm for automatically analyzing and understanding given content such as text, images, audio, videos, and the like. The content analysis model processes data according to a specific form of content using AI and machine learning technologies and extracts meanings or recognizes features. According to the exemplary embodiment, the content analysis model may include, but is not limited to, a text analysis model, an image analysis model, an audio analysis model, a video analysis model, and the like. According to the exemplary embodiment, the generation unit 137 uses the content analysis model to check information on the interviewee's education, career, skills, certifications, and the like from the cover letter and resume, and to check the interviewee's actual projects, work, achievements, and the like from the portfolio. Subsequently, the generation unit 137 identifies the interviewee's experience and competencies by checking data through the content analysis model. For example, the generation unit 137 checks what work experience the interviewee has, what skills and qualities the interviewee has, what projects the interviewee has worked on, and what results the interviewee has achieved. Also, the generation unit 137 analyzes the data to evaluate the interviewee's abilities, competencies, suitability, motivation, and the like. The generation unit 137 interprets how the interviewee's experience and projects are related to the company or organization and how the interviewee's experience and projects are suitable for a job that the interviewee applies for, and uses this to generate an additional question.

For example, when the interviewee mentions a specific project on the resume and describes that he or she took a leadership role in the project, the generation unit 137 may generate “You mentioned that you took a leadership role in a project. Tell me about the leadership style you used to get your team members to work well together” and the like as an additional question based on resume analysis results.

Also, according to the exemplary embodiment, the generation unit 137 may generate an additional question on the basis of analysis results of the data submitted by the interviewee and the additional items. This additional question is generated regarding the additional items that are unidentifiable from the previous questions and answers during the interview process on the basis of the analysis results of the data submitted by the interviewee to identify the interviewee in depth.

For example, when the problem-solving capability is an additional item, the generation unit 137 may generate an additional question for identifying the interviewee's problem-solving capability on the basis of the data submitted by the interviewee. Specifically, the generation unit 137 may generate an additional question, such as “Can you tell me more about the project you mentioned in your portfolio, especially the challenges you faced in the project process and how you addressed them?” to identify the problem-solving capability.

After analyzing the data submitted by the interviewee, the generation unit 137 may identify the interviewee's competencies according to evaluation items and select an item which is insufficiently identified as an additional item to generate an additional question.

Also, the generation unit 137 selects and combines some of all questions and answers provided to and by the interviewee as well as an immediately previous question and answer collected by the collection unit 131.

To this end, the generation unit 137 collects all questions and answers provided to and by the interviewee during the interview process and identifies content of each question and answer through the answer analysis model. Here, the generation unit 137 identifies main topics or key points that have been asked of the interviewee during the interview process. These topics may include the interviewee's career, competencies, achievements, motivation, and the like. Subsequently, the generation unit 137 analyzes the selected questions and answers on the basis of the main topics or key points to generate an additional question for the interviewee. Here, questions may be designed to dive into previous answers of the interviewee or to connect the answers to other topics to obtain information from a new perspective. For example, the generation unit 137 may generate a new tail question by combining or linking the selected questions and answers together. The generation unit 137 may generate questions that prompt the interviewee to organically combine what the interviewee has previously mentioned with other topics and to provide more in-depth information.

Specifically, when the interviewee has answered an interview question about his or her previous project experience, the generation unit 137 may utilize selected content to design additional questions as follows.

Interviewee's answer: “I took a leadership role in the project and collaborated with team members to successfully complete it.”

Additional question 1: “What challenges did you face working with team members on your project and how did you overcome them?”

Additional question 2: “Why do you think the project was successful? Did you use a particular strategy or approach?”

According to the exemplary embodiment, the selected answers and questions are combined to generate an additional question, which makes it possible to acquire more information from the interviewee and also allows the interviewee to give an in-depth answer. This allows the conversation with the interviewee to be effectively guided during the interview process, allowing accurate evaluation of the interviewee.

The generation unit 137 may interpret a question-answer pair acquired on the basis of the STAR technique. For example, when the interviewee mentions a task, an action, and a result without a situation in his or her answer, the generation unit 137 may generate a tail question for inquisitively asking the interviewee about the situation.

To this end, the generation unit 137 understands the STAR technique using the answer analysis model and interprets questions used in the interview and the interviewee's answers. Here, the generation unit 137 identifies the situation, task, action, and result items. Subsequently, the generation unit 137 identifies missing items. For example, when the interviewee does not mention any situation in his or her answer, the generation unit 137 identifies this and infers the missing situation. According to the exemplary embodiment, the generation unit 137 may infer a possible situation on the basis of a task, an action, and a result given in the answers. Subsequently, the generation unit 137 generates a tail question for the interviewee about the missing situation. This question prompts the interviewee to elaborate on the situation.

Specifically, when the interviewee answers interview questions according to the STAR technique but mentions a task, an action, and a result without a situation in the answers, the generation unit 137 may generate a tail question as follows.

Specifically, when a question based on the STAR technique is “Describe your primary responsibilities on a past project” and the interviewee's answer is “On the project, I planned the project schedule, coordinated cooperation among team members, and successfully completed the project,” the generation unit 137 may generate, as a tail question for identifying the situation item, “What was the situation when you started working during the project? What challenges did you face in the situation and what actions did you take to address the challenges?” and the like.

Also, the generation unit 137 evaluates the interviewee's level or emotion and adjusts the difficulty of the tail question according to the interviewee's evaluated level. To this end, the generation unit 137 evaluates answers given by the interviewee during the interview process. Here, the generation unit 137 may evaluate the content, logic, problem-solving capability, professionalism, candor, and the like of the answers through the answer analysis model. Also, the generation unit 137 evaluates the interviewee's level. For example, the generation unit 137 may derive variables of the interviewee's knowledge, experience level, competencies, qualities, confidence, and the like according to answer evaluation results and identify the interviewee's level on the basis of each variable.

Also, the generation unit 137 identifies the interviewee's emotion during the answering process. According to the exemplary embodiment, when the interviewee's answers are recorded as image information, the generation unit 137 may identify the interviewee's emotion through image analysis, that is, analysis of the interviewee's facial expressions, voice, and motions. According to the exemplary embodiment, the generation unit 137 may identify whether the interviewee is confident or insecure in his or her experience or competencies.

Subsequently, the generation unit 137 adjusts the difficulty of a tail question in consideration of the interviewee's level and emotion. When the interviewee's level or confidence is a certain level or higher, the generation unit 137 generates an in-depth question or a challenging question as a tail question. On the other hand, when the interviewee's level is below the certain level or the interviewee is insecure, the generation unit 137 generates an easier or stabler question as a tail question.

When the interviewee is estimated to be nervous or the level of answers is determined to be a certain level or lower, the generation unit 137 generates an example answer. According to the exemplary embodiment, the generation unit 137 generates an example answer in consideration of a case where the interviewee is nervous or the level of answers is below the certain level. Here, the generation unit 137 designs an example answer for the interviewee to accurately answer in detail with confidence.

Specifically, when the interviewee nervously and briefly answers a question about project experience, the generation unit 137 may design an example answer as follows.

Example answer: “In the past project, my role was a team leader. I set the project schedule, identified the competencies of my team members and divided tasks efficiently. Also, when a problem arose, I communicated with my team members to find an effective solution. This led to the successful completion of the project.”

According to the exemplary embodiment, when the interviewee does not respond for a certain period of time after the interviewer provides a question, the generation unit 137 allows output of an example answer after the certain period of time.

Also, when the interviewee's nervousness is very high or the interviewee is silent for a period of time or more, the generation unit 137 generates an icebreaking question for changing the atmosphere. According to the exemplary embodiment, the generation unit 137 may generate an icebreaking question on the basis of the analysis results of the data submitted by the interviewee and the interviewee's personal information. In addition, the generation unit 137 may generate an icebreaking question from a recent issue or article.

Further, when the interviewee stops while answering and a certain amount of time elapses or the interviewee makes an utterance indicative of his or her nervousness, such as “I'm sorry,” “I'm too nervous,” or the like, the generation unit 137 may output an icebreaking question or a relaxation message to reduce nervousness. According to the exemplary embodiment, the relaxation message may be “Don't be nervous,” “Feel free to talk,” or the like.

The feedback unit 139 evaluates a trained artificial neural network model and a DNN model. According to the exemplary embodiment, the feedback unit 139 may evaluate the artificial neural network model using at least one of accuracy, precision, and recall. Accuracy is a metric indicating how well results predicted by an artificial neural network model match actual results. Precision is a metric indicating a ratio of results that are predicted to be positive and actually positive to results that are predicted to be positive. Recall is a metric indicating a ratio of results that are predicted to be positive by a model and actually positive to results that are actually positive. According to the exemplary embodiment, the feedback unit 139 may calculate the accuracy, precision, and recall of an artificial neural network model and evaluate the artificial neural network model on the basis of at least one of the calculated metrics.

According to the exemplary embodiment, the feedback unit 139 may measure the accuracy of an artificial neural network model using an evaluation dataset. The evaluation dataset includes data that is not used for training a model and is used for objectively evaluating performance of a model. According to the exemplary embodiment, the feedback unit 139 executes an artificial neural network model using the evaluation dataset and compares a prediction value of the artificial neural network model for each piece of input data with a correct answer value of the data. Subsequently, it may be measured from the comparison result how accurately the model predicts. For example, the feedback unit 139 may calculate the accuracy as a ratio of data correctly predicted by the model to all data.

Also, the feedback unit 139 may calculate an F1 score that is calculated as the harmonic mean of precision and recall scores to represent balance between precision and recall, evaluate an artificial neural network model on the basis of the calculated F1 score, generate an area under the curve (AUC) receiver operating characteristic (ROC) curve which is a metric visualizing the performance of a classification model, and evaluate the artificial neural network model on the basis of the generated AUC-ROC curve. According to the exemplary embodiment, when an area under the ROC curve (AUC) is closer to 1, the feedback unit 139 may evaluate the performance of the model more highly.

In addition, the feedback unit 139 may evaluate the interpretation possibility of an artificial neural network model. According to the exemplary embodiment, the feedback unit 139 evaluates the interpretation possibility of an artificial neural network model using Shapley Additive explanations (SHAP) or Local Interpretable Model-agnostic Explanations (LIME). SHAP is a library that provides an interpretation of a prediction result of a model, and the feedback unit 139 extracts an SHAP value from the library. According to the exemplary embodiment, the feedback unit 139 may extract an SHAP value to estimate how much a prediction of a model is affected by feature information input to the model.

LIME is a method of describing a prediction of a model for each individual sample. According to the exemplary embodiment, the feedback unit 139 calculates the importance of each piece of feature information by approximating a sample using an interpretable model on the basis of LIME. Also, the feedback unit 139 may analyze internal weights and bias values of a model to estimate the influence of each feature variable.

When an artificial neural network model shows poor fairness or discrimination, the feedback unit 139 performs an improvement task. According to the exemplary embodiment, when data of a specific group is insufficient by a certain amount or more, the feedback unit 139 additionally collects data representative of the specific group and performs a data preprocessing process. According to the exemplary embodiment, the feedback unit 139 performs a data preprocessing process including data normalization, outlier removal, and data scaling to prevent the model from learning unnecessary patterns. Also, according to the exemplary embodiment, the feedback unit 139 may add a specific condition to a model training algorithm to prevent discrimination or ensure fairness.

According to the exemplary embodiment, the feedback unit 139 evaluates the performance of a model by comparing a prediction result of the model with an actual result through confusion matrix analysis. A confusion matrix is a matrix for evaluating the classification performance of a model in supervised learning. The confusion matrix compares a prediction result of the model with an actual result to display a classification result. According to the exemplary embodiment, the feedback unit 139 may evaluate the performance of the model by calculating accuracy and a misclassification rate for each class through confusion matrix analysis.

According to the exemplary embodiment, the feedback unit 139 allows check of training data distribution through visualization analysis of the data. For example, in the case of image data, image samples of each class may be visualized to evaluate diversity and fairness of the data.

The feedback unit 139 verifies bias of an artificial neural network model. According to the exemplary embodiment, the feedback unit 139 verifies bias of training information to determine whether a model is biased in favor of a certain class or attribute. To this end, the feedback unit 139 compares the numbers of samples of classes or evaluates classification performance of each class.

The feedback unit 139 verifies fairness and calculates an evaluation metric to verify fairness and diversity of training data and improve an artificial neural network model. According to the exemplary embodiment, fairness verification involves determining whether training information shows discrimination against a specific attribute of artificial neural networks. According to the exemplary embodiment, the feedback unit 139 may compare the numbers of samples of attributes or evaluate classification performance of each class to determine whether a specific attribute is discriminated.

The feedback unit 139 calculates various metrics for evaluating performance of an artificial neural network model. For example, accuracy, precision, recall, an F1 score, and the like may be calculated to evaluate performance of the model. Here, a metric of each class may be calculated to evaluate fairness and diversity of the model.

The feedback unit 139 collects feedback on a problem occurring when an artificial neural network model is used in an actual environment and reflects the collected feedback in the artificial neural network model to continuously improve the artificial neural network model.

A method of generating a tail question will be described below. Since actions (functions) of the method of generating a tail question are fundamentally the same as functions of the system, the same description as that of FIGS. 1 to 6 will be omitted.

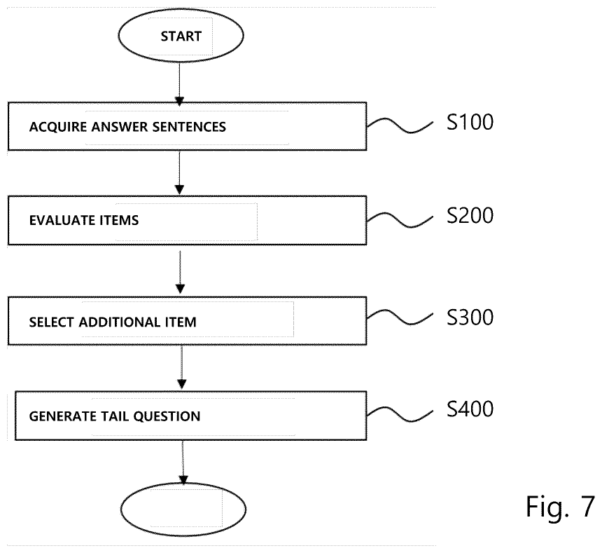

FIG. 7 is a flowchart illustrating a data processing process of a question generation server according to an exemplary embodiment.

Referring to FIG. 7, in operation S100, answer sentences given by an interviewee are acquired for an interviewer's interview questions about a job that the interviewee applies for. In operation S200, each of a plurality of evaluation items required for evaluating suitability for the job is evaluated on the basis of the acquired answer sentences. In operation S300, an additional item to be additionally evaluated is selected from among the plurality of evaluation items on the basis of the performed evaluation. In operation S400, a tail question is generated on the basis of at least one of the selected additional item, the interview questions, and the acquired answer sentences.

According to the above-described server and method for generating interview questions on the basis of AI, tail questions in which evaluation elements are combined with questions and answers provided to and from an interviewee are automatically generated to accurately evaluate the interviewee's competencies through the interview.

Also, according to exemplary embodiments, the content of data, such as a resume, a portfolio, a cover letter, and the like, submitted by an interviewee is grasped and used to generate and provide additional questions such that the interviewee can be understood in depth.

According to exemplary embodiments, additional questions can be generated to disclose an interviewee's experience and competencies in detail, and it is possible to obtain in-depth information through a conversation with the interviewee in the interview process.

Also, additional questions help an interviewer to evaluate an interviewee's competencies and suitability and can increase the efficiency and accuracy of the interview process.

Also, according to exemplary embodiments, more information is obtained from an interviewee, and the interviewee is allowed to give a deep answer, which effectively guides a conversation in the interview process.

Also, according to exemplary embodiments, tail questions allow an interviewee to elaborate on a situation, enriching a conversation with the interviewee and making it possible to obtain meaningful information during the conversation.

Also, according to exemplary embodiments, sample answers are generated to help an interviewee answer in detail with confidence. In this way, it is possible to improve the interviewee's answers, reduce his or her nervousness, and obtain meaningful information in the interview process.

Also, according to exemplary embodiments, tail questions are used to check whether an interviewee is exaggerating his or her career or lying, increasing the reliability of interview answers.

Effects of the present invention are not limited to those described above and are construed as including all effects that are derivable from the inventive configuration in the detailed description of the present invention or the claims.

The disclosure is illustrative only. Since various modifications can be made by those of ordinary skill in the art without departing from the spirit of the claims, the scope of the disclosure is not limited to the specific embodiments described above.

What is claimed is:

1. A server for generating a question on the basis of artificial intelligence (AI), the server comprising:
a memory configured to store at least one instruction; and
a processor;
wherein, when the at least one instruction is executed by the processor, the server acquires answer sentences given by an interviewee for an interviewer's interview questions about a job that the interviewee applies for,
evaluates each of a plurality of evaluation items required for evaluating suitability for the job on the basis of the acquired answer sentences;
selects an additional item to be additionally evaluated from among the plurality of evaluation items on the basis of the evaluation, and
generates a tail question on the basis of at least one of the selected additional item, the interview questions, and the acquired answer sentences and provides the tail question to the interviewee.
wherein the server further evaluates the interviewee's level based the answer sentences to the interview questions using a pre-trained answer analysis model based on a language model, and
wherein the server adjusts a difficulty of tail question to be higher than that of the interview questions when the answer analysis model evaluates the answer sentences as above a predetermined level and adjust the difficulty of tail question to be lower than that of the interview questions when the answer analysis model evaluates the answer sentences as below the predetermined level.

2. The server of claim 1, wherein the server understands content of data submitted by the interviewee, which includes a cover letter, a resume, credentials, and a portfolio, and generates an additional question about the content of the submitted data.

3. The server of claim 1, wherein the server selects and combines some of all questions and answers provided to and by the interviewee as well as an immediately previous question and answer to generate the tail question.

4. The server of claim 1, wherein the plurality of items include key competencies required for the job.

5. The server of claim 1, wherein the plurality of items include situation, task, action, and result which are defined in a situation, task, action, and result (STAR) technique.

6. The server of claim 1, wherein, after providing the tail question to the interviewee, the server additionally provides an example answer for the tail question to the interviewee.

7. The server of claim 6, wherein the example answer is provided when the interviewee is estimated to be nervous or a level of answers is determined to be a certain level or lower.

8. The server of claim 1, wherein the server extracts an item that is unidentified from the content of the data submitted by the interviewee and generates an additional question for evaluating the item.

9. The server of claim 1, wherein, when the interviewee's nervousness exceeds a certain level or the interviewee is silent for a certain period of time or more or stops speaking while answering, the server generates an icebreaking question for changing an atmosphere or outputs a nervousness relaxation message.
